(19) United States
(12) Patent Application Publication
(10) Pub. No.: US 2019/0043139 A1
(43) Pub. Date: Feb. 7, 2019

(54) SYSTEMS AND METHODS FOR DISTRIBUTING ELECTRONIC CONTENT AND SOLICITING COMPOUND USER-GENERATED SOCIAL NETWORK INTERACTIONS

(71) Applicant: Feedback Networks, LLC, Arlington, VA (US)

(72) Inventors: Dana LOVE, Scottsdale, AZ (US); Nicholas UNGER, Arlington, VA (US)

(73) Assignee: Feedback Networks, LLC

(21) Appl. No.: 16/036,774

(22) Filed: Jul. 16, 2018

Related U.S. Application Data
(60) Provisional application No. 62/534,027, filed on Jul. 18, 2017.

(51) Int. Cl. G06Q 50/00; H04L 29/08; G06F 17/30; G06F 17/15; G06Q 20/14; G06Q 30/02

(52) U.S. Cl. CPC G06Q 50/01; H04L 67/306; G06F 17/30867; G06Q 30/0201; G06F 17/30964; G06Q 20/145; G06F 17/15

(57) ABSTRACT

Systems and methods for making a series of social interactions for a single user of one or many social networking utilities, comprising a single button click or an series of button clicks abstracted from the one or many social networking utilities, wherein the sense of the abstracted button click(s) is correlated to interactions on one or many social networking utilities, and then translated via networking connection to the various social networking utilities as if the single user had initiated a series of specific social interactions.

### CROSS-REFERENCE TO RELATED APPLICATION

This application claims the benefit of priority from U.S. Provisional Application No. 62/534,027, filed on Jul. 18, 2017, which is incorporated by reference herein in its entirety.

### TECHNICAL FIELD

Various embodiments of the present disclosure relate generally to novel social network engagement methods and systems, and more particularly, to enabling users to interact with multiple social networks.

### BACKGROUND

The Internet has redefined how consumers and businesses interact with each other, providing consumers with instant or near-instant access to online purchasing, and creating a unique marketing and distribution channel for businesses to reach their audiences. Businesses have been able to increase the effectiveness of targeting customers through the web and over mobile applications; however, the art and science of reaching target audiences is still very much in development.

E-commerce (electronic commerce) has empowered consumers with the ability to obtain information on anything for sale online, at any time, from hundreds of millions of contributors around the world. Existing recommendation systems in online e-commerce portals allow users to research and create recommendations on items and services for sale, restaurants, locations, and so forth. Many of these systems allow for open access; in other words, anyone, anywhere can create content (i.e., an interaction). Systems for providing interactions across social networks based on relationships to an individual creating content online have not yet evolved to a mature state. At most, interactions may take into account relationships that interested parties have with other members of a single social network utility.

Another type of application on the Internet that has recently grown in popularity is the social network. Social networks allow individuals to connect with others through a mapping of relationships, whether by representations of personal friendships, business relationships, common interests, or other relationships. One individual typically makes use of many social network providers to capture the totality of their friendships, relationships, and interests on the Internet. Social networks have begun to incorporate e-commerce functionality through targeted and non-targeted advertising systems, but these technologies have not yet developed to their full potential. Social networks are rich in relationship information, but have yet to harness it to empower businesses to connect with individuals, and vice-versa.

### SUMMARY OF THE DISCLOSURE

In general, in one aspect, the present disclosure relates to a method for making a series of interactions on various social networks on behalf of a member through a single request by that member, comprising: obtaining the nature of the interaction sought by the member through selection from an array of options; gathering, storing for future use, and using the member's credentials for access to the various social network utilities with which the member is interacting; translating the nature of the interaction sought by the member from their previous selection into formats and content for the various social network utilities through an administratively provided translation matrix; and transacting with the various social network utilities to complete all interactions on behalf of member.

In general, in one aspect, the present disclosure relates to a system for making a series of interactions with an arbitrary number of social networks, comprising: a processor; a memory operatively connected to the processor; and an interaction engine resident in memory and configured to: generate an interface to present to a user an array of interaction options; generate an interface to receive from the user the type of interaction to be conducted; display the outcome that the interaction has been conducted; and interact with a credentialing module such that user access credential information can be provided by user, identified by the credentialing module as a particular user of present disclosure, and allowing for both initial authorizations and reauthorizations for an arbitrary number of social networks.

In general, in one aspect, the present disclosure relates to a system for making a series of interactions with an arbitrary number of social networks, comprising: a processor; a memory operatively connected to the processor; and a credentialing module resident in memory and configured to: obtain user access credential information for each of the arbitrary number of social networks; validate and obtain user access authorization for each of the access credentials from the relevant social network; link the arbitrary number of user access credentials to a particular user of the present disclosure; and store the assembled information in memory.

In general, in one aspect, the present disclosure relates to a system for making a series of interactions with an arbitrary number of social networks, comprising: a processor; a memory operatively connected to the processor; and a translation engine resident in memory and configured to: receive and store instructions from an administrative user, the instructions comprising one-to-one or one-to-many translations between each of an array of interaction options presented by an interaction engine and each of an arbitrary number of social networks.

In general, in one aspect, the present disclosure relates to a system for making a series of interactions with an arbitrary number of social networks, the system comprising: a processor; a memory operatively connected to the processor; and a transaction module resident in memory and configured to: receive a user interaction request from an interaction engine, to include the unique identifier for the user; use the unique identifier for the user to gather user access credential information for each of an arbitrary number of social networks from a credentialing module; conduct one or many transactions of information with an arbitrary number of social networks using translation information provided by a translation engine such that the user interaction request to a variety of social interaction queues between and among social network platforms; and present successful completion of the user interaction request to an interaction engine to allow the user to know the interaction or interactions have been completed.

Other aspects and advantages of the present disclosure will be apparent from the following description and the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate various examples and together with the description, serve to explain the principles of the disclosure.

FIG. 1 shows a system for social network engagement methods and for enabling users to interact with multiple social networks, in accordance with one or more embodiments of the present disclosure.

FIGS. 2 and 3 show flowcharts of exemplary methods for social network engagement methods and for enabling users to interact with multiple social networks, in accordance with one or more embodiments of the present disclosure.

FIGS. 4 and 5 shows flowcharts of exemplary methods for social network engagement methods and for enabling users to interact with multiple social networks in accordance with one or more embodiments of the present disclosure.

FIG. 6 shows a computer system in accordance with one or more embodiments of the present disclosure.

### DETAILED DESCRIPTION

Specific embodiments of the present disclosure will now be described in detail with reference to the accompanying figures. Like elements in the various figures are denoted by like reference numerals for consistency.

In the following detailed description of embodiments of the present disclosure, numerous specific details are set forth in order to provide a more thorough understanding of the present disclosure. However, it will be apparent to one of ordinary skill in the art that the present disclosure may be practiced without these specific details. In other instances, well-known features have not been described in detail to avoid unnecessarily complicating the description.

The present disclosure relates generally to novel social network engagement methods and systems for abstracting social networks to enable individuals to engage with multiple social networks with one or few interactions. More specifically, exemplary embodiments of the present disclosure relate to systems and methods for businesses to streamline the creation of an individual's recommendation for said business across multiple social networks, for the creation of an individual's content across multiple social networks, and for capturing all related data necessary to facilitate interactions in real-time. Other embodiments and advantages of the present disclosure will be apparent from the following description and the appended claims.

In general, embodiments of the present disclosure provide a system and method for mapping a single user initiated expression of a social network interaction to one or many interactions across one or many social network utilities. Further, embodiments of the present disclosure provide a system and method for providing recommendations on content for purchase in a social network. Further, embodiments of the present disclosure provide a system and method for managing inventory of items for sale in a social network.

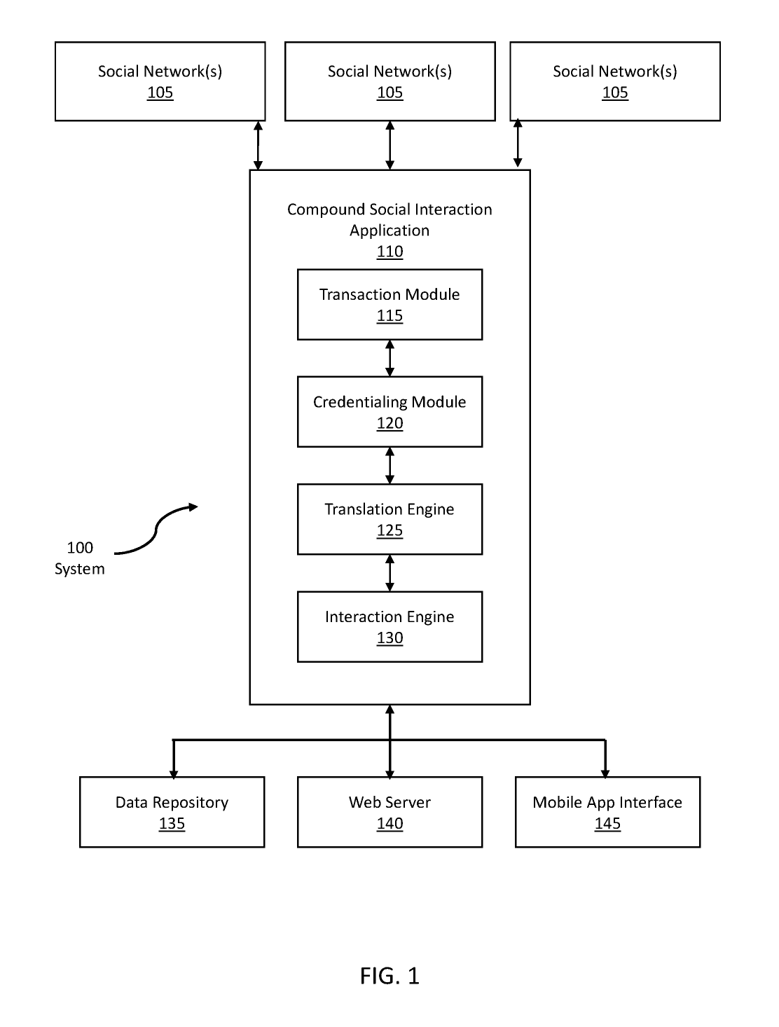

FIG. 1 shows a system (100) in accordance with one or more embodiments of the present disclosure. As shown in FIG. 1, the system (100) has multiple components including a compound social interaction application (110), a data repository (135), a web server (140), a mobile app interface (145), and one or more social networks (105) in accordance with one or more embodiments of the present disclosure. These components are described below and may be located on the same device (e.g. a server, mainframe, desktop Personal Computer (PC), laptop, Personal Digital Assistant (PDA), telephone, mobile phone, kiosk, cable box, radio receiver (AM, FM, satellite, Internet, or other), smart speaker (e.g. Amazon Echo, Apple HomePlay), and any other device) or may be located on separate devices connected by a network (e.g. the Internet), with wired and/or wireless segments. Those skilled in the art will appreciate that there may be more than one compound social interaction application, data repository, web server, and mobile app interface running on a device, as well as more than one social network interfacing with those components.

In one or more embodiments of the present disclosure, each of a plurality of social networks (105) may be connected to a compound social interaction application (110), and provide programming hooks for the compound social interaction application (110) to plug into the social network (105). Each social network (105) is a community of connected individuals, with relationships that may be social, professional, or the like. In a social network where individuals are connected by friendships (or other trusted relationship), there may be increased value in sharing of content (e.g. music, videos, text, images, graphics, or commercial opportunities, such as e.g., coupons, discounts, direct buying opportunities, advertisements, etc.) from friends over content shared by acquaintances or non-friends. Individuals may participate in more than one social network (105), and may have different connections by friendships or other trusted relationships on those different social networks. When an individual creates or shares content, that content is distributed to friends, acquaintances, and non-friends on multiple social networks in which the individual participates. When an individual interacts with content through an expression of interest or other type of interaction in the content of other individuals (non-comprehensive exemplars to include options for love, respect, like, dislike, avoid, share, honor, cheer, chat, tell, cherish), that interaction is distributed to friends, acquaintances, and non-friends on multiple social networks in which the individual participates.

The concept of a compound interaction across social networks in which an individual participates in content creation, curation, and interaction with friends and similar relationships may also extend to individuals that are indirectly connected through mutual friendships. For example, if a member of a social network (e.g. individual A) is connected to a member sharing content (e.g. individual B) through 7 mutual friends, but individual A and individual B are not friends themselves, individual A may still derive benefit from content shared by individual B. Similarly, if individual A is a member of one social network (social network Z) while individual B is a member of both social network Z and a second social network (social network Y), individual A would not otherwise be exposed to content from social network Y in which a higher than typical value can be derived because of their direct or indirect connection with individual B and because of their participation in only one social network. Those skilled in the art will appreciate that there will be many other such relationships and valuable interactions associated with a social network (105) and a compound social interaction application (110).

In one or more embodiments of the present disclosure, a compound social interaction application (110) contains a transaction module (115), a credentialing module (120), a translation engine (125), and an interaction engine (130).

In one or more embodiments of the present disclosure, the transaction module (115) is configured to connect the compound social interaction application (110) to the social network (105). This connection is typically accomplished through the use of an application programming interface (API), provided by the social network (105). The transaction module (105) accepts and receives social network membership credential information from the compound social interaction application (110) and the credentialing module (120) such that the connection with the social network (105) can be conducted without the social network member entering their credentials manually for each use of the compound social interaction application (110). The transaction module (115) may also maintain information (text, images, metadata, and other information) requested by the translation engine (125) to provide rapid access to the information when not connected to a network. The transaction module (115) may also provide for synchronization between the compound social interaction application (110), the data repository (135), the web server (140), the mobile app interface (145), and the social network (105).

In one or more embodiments of the present disclosure, the credentialing module (120) is configured to receive input on access credential information for a social network (105) from users of the social network (105). The compound social interaction application may interact with one or many social networks (105). The credentialing module (120) may also maintain information (access credential information, and other information) requested by the transaction module (115) to provide rapid access to the information when not connected to a network. The credentialing module (120) may also provide for synchronization between itself and the data repository (135).

In one or more embodiments of the present disclosure, the translation engine (125) is configured to obtain input on interaction types specific to a social network (105) from administrative users of the web server (140), to obtain input on interaction types not specific to any social network from administrative users of the web server (140), and to obtain input on the correlation between the two from administrative users of the web server (140). The compound social interaction application (110) interacts with the transaction module (115) and the interaction engine (130) to complete the user generated social interaction, may interact with one or more financial applications (not shown) for managing financial transactions, one or more social networking utility applications for access to multiple social networks (105), one or more adaptive learning applications or big data applications (not shown) for managing operational systems and content (interactions types specific to a social network (105), interaction types not specific to any social network, correlation matrix, or other information), and other similar systems. In one or more embodiments, the compound social interaction application (110) provides users with motivation and incentive to interact and engage with businesses and other individual users in a social network environment, as users may now participate in a customized and multi-platform environment that is connected across social networks (105) for their friends, acquaintances, and business relationships. Additionally, the compound social interaction application (110) provides businesses with incentives to maintain a presence on social networks, as they are provided with a new marketing and sales channel, and a new way to interact with potential customers and partners. Those skilled in the art, having the benefit of this detailed description, will appreciate that there are numerous other reasons and mechanisms for members of various social networks and businesses to interact through the compound social interaction application (110).

In one or more embodiments of the present disclosure, the interaction engine (130) is configured to obtain input on interaction types not specific to any social network from the translation engine (125), and to obtain inputs (e.g. the selection of the type of interaction) from users of the compound social interaction application (110) through the web server (140) or the mobile app interface (145). The interaction engine (130) interacts with the translation engine (125) and credentialing module (120) to complete the user generated social interaction, and may interact with the data repository (135) to store data related to the social interaction. Those skilled in the art, having the benefit of this detailed description, will appreciate that there are numerous other reasons and mechanisms for members of various social networks and businesses to interact through the compound social interaction application (110).

In one or more embodiments of the present disclosure, a data repository (135) is configured to contain the data (and other content capable of being stored) associated with providing compound social interactions on the social network (105). The data repository (135) is operatively connected to the compound social interaction application (110), the web server (140), and the mobile app interface (145) to allow for communication between the various component and/or services necessary to accomplish the present disclosure.

In one or more embodiments of the present disclosure, a web server (140) is configured to host the compound social interaction application (110), including the transaction module (115), the credentialing module (120), the translation engine (125) and the interaction engine (130). The web server may be configured to serve content to users based on requests. Upon receiving a request to conduct a social interaction, for example, the web server responds to the sender of the request with the data sufficient to satisfy the request. Those skilled in the art, having the benefit of this detailed description, will appreciate that the web server (140) may be connected to the compound social interaction application (110), data repository (135), and the mobile app interface (145) through numerous network configurations (e.g. wired, wireless, LAN, WAN, and so forth.)

In one or more embodiments of the present disclosure, a mobile app interface (145) is configured to serve content to users based on requests. Upon receiving a request to conduct a social interaction, for example, the web server responds to the sender of the request with the data sufficient to satisfy the request. Those skilled in the art, having the benefit of this detailed description, will appreciate that the mobile app interface (145) may be connected to the compound social interaction application (110), data repository (135), and the web server (140) through numerous network configurations (e.g. wired, wireless, LAN, WAN, and so forth.)

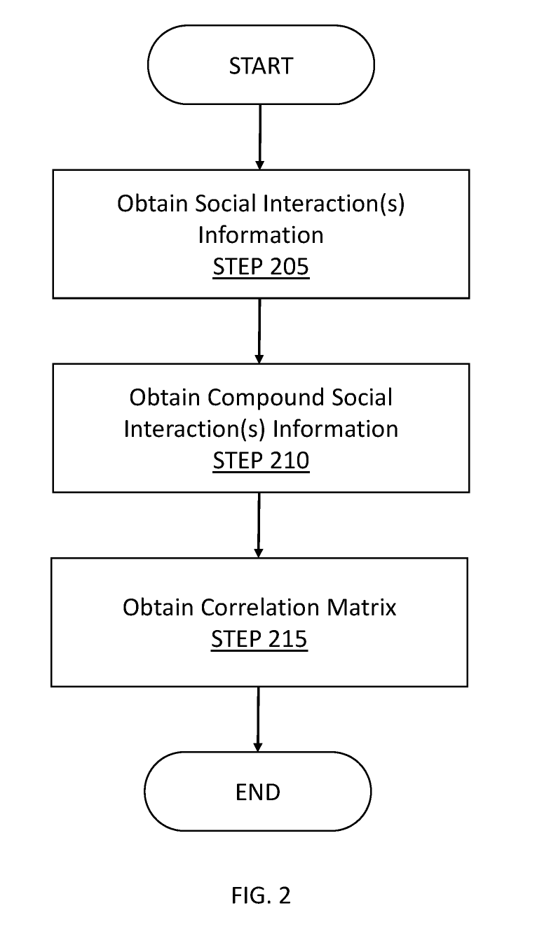

FIG. 2 shows a flowchart in accordance with one or more embodiments of the present disclosure. The process shown in FIG. 2 may be used, for example, with the system (100), to obtain social interaction correlation information from administrative users of the system (100). Those skilled in the art, having the benefit of this detailed description, will appreciate that the sequence of steps shown in FIG. 2 may differ among embodiments of the present disclosure, and that one or more of the steps may be optional.

In STEP 205, information about social interaction types on one or many social network (105 in FIG. 1) utilities is obtained and/or stored in accordance with one or more embodiments of the present disclosure. As used herein the social interaction types may be content data representing a good, a service, an organization, an event, a concept, an emotion, etc. The interactions in STEP 205 come from social network providers like Google, Facebook, Snap, and others, and are simply catalogued for compounding in later steps. Additional tracking and qualifying of data may be performed. Also, the social interaction types contained herein are obtained and processed prior to a user request of the compound social interaction application (110 in FIG. 1).

In STEP 210, information about compound social interaction types is obtained and/or stored in accordance with one or more embodiments of the present disclosure. As used herein, compounded interaction types may be content data representing a good, a service, an organization, an event, a concept, an emotion, etc. The interactions in STEP 210 are implemented by administrative users of the system (100 in FIG. 1) in accordance with one or more embodiments of the present disclosure. Typically, compound social interaction types may be obtained from businesses or groups with or interested in the social interactions on their various web sites and mobile applications.

In STEP 215, correlation information is obtained and/or stored in accordance with one or more embodiments of the present disclosure. As used herein, correlation information may be a matrix mapping one compound social interaction type to one or many social interaction types. The correlation matrix in STEP 215 is implemented by administrative users of the system (100 in FIG. 1) in accordance with one or more embodiments of the present disclosure. Also, the correlation information is obtained and processed prior to a request for a compound social interaction.

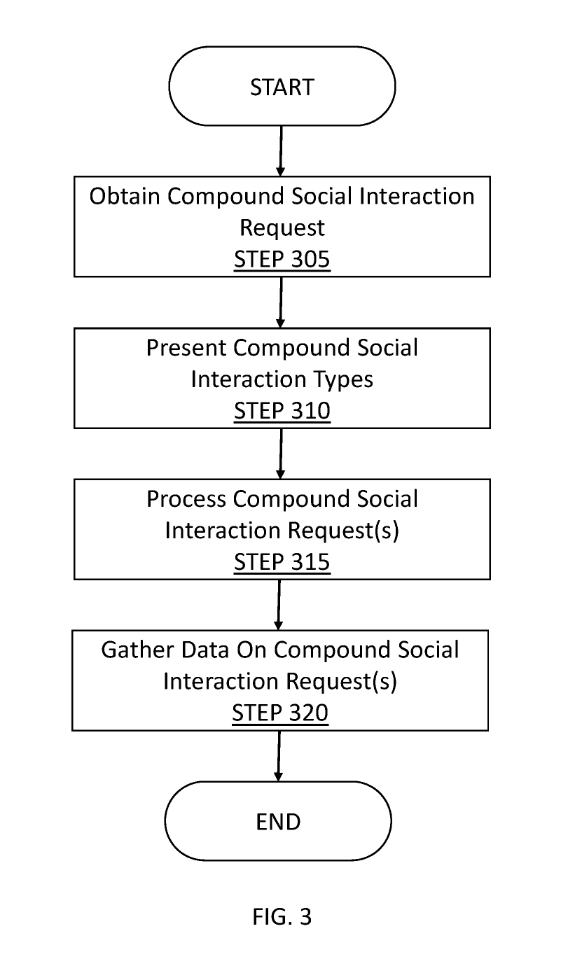

FIG. 3 shows a flowchart in accordance with one or more embodiments of the present disclosure. The process shown in FIG. 3 may be used, for example, with the system (100), to obtain and process requests for compound social interactions from users of the system (100). Those skilled in the art, having the benefit of this detailed description, will appreciate that the sequence of steps shown in FIG. 3 may differ among embodiments of the present disclosure, and that one or more of the steps may be optional.

In STEP 305, a user initiates a request for a compound social interaction. As used herein, this request may come from the web server (140 in FIG. 1) or the mobile app interface (145 in FIG. 1), where a mobile app or web site outside the system has placed software to initiate such request(s).

In STEP 310, the user receives the compound social interaction types (210 in FIG. 2) appropriate for that user and that mobile app or web site outside the system which has placed software to handle such receipt.

In STEP 315, the user initiates a request for the system (100 in FIG. 1) to complete a compound social interaction on the user's behalf, the request is fulfilled, and the user is notified that the interaction is complete. The compound social interaction may specify parameters, including specific friends or acquaintances to send the compound social interaction to, social network utilities to include or exclude from the search, and other characteristics that are often specified in a social interaction. Alternatively, a compound social interaction may be performed without parameters, which allows for the rapid interaction across many social networks. This encourages spontaneity of social interaction, and blends the various networks of friends and acquaintances that a user has among all their social network utility participations.

In STEP 320, the system (100 in FIG. 1) collects various data on compound social interaction requests. This data collection may include information from inside the compound social interaction application (110 in FIG. 1) and may include information from outside the system (100 in FIG. 1), to include location information, the content of the compound social interaction, the social networks were the compound social interaction was sent, who viewed the social interactions on the social networks, and any other information available. Those skilled in the art, having the benefit of this detailed description, will appreciate the breadth of this data collection.

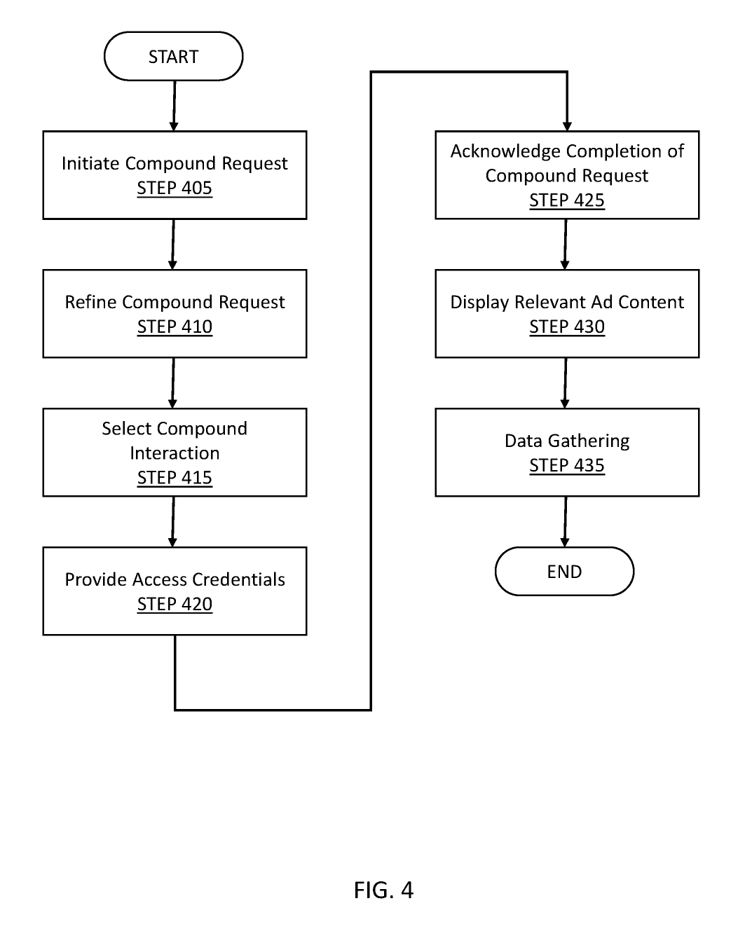

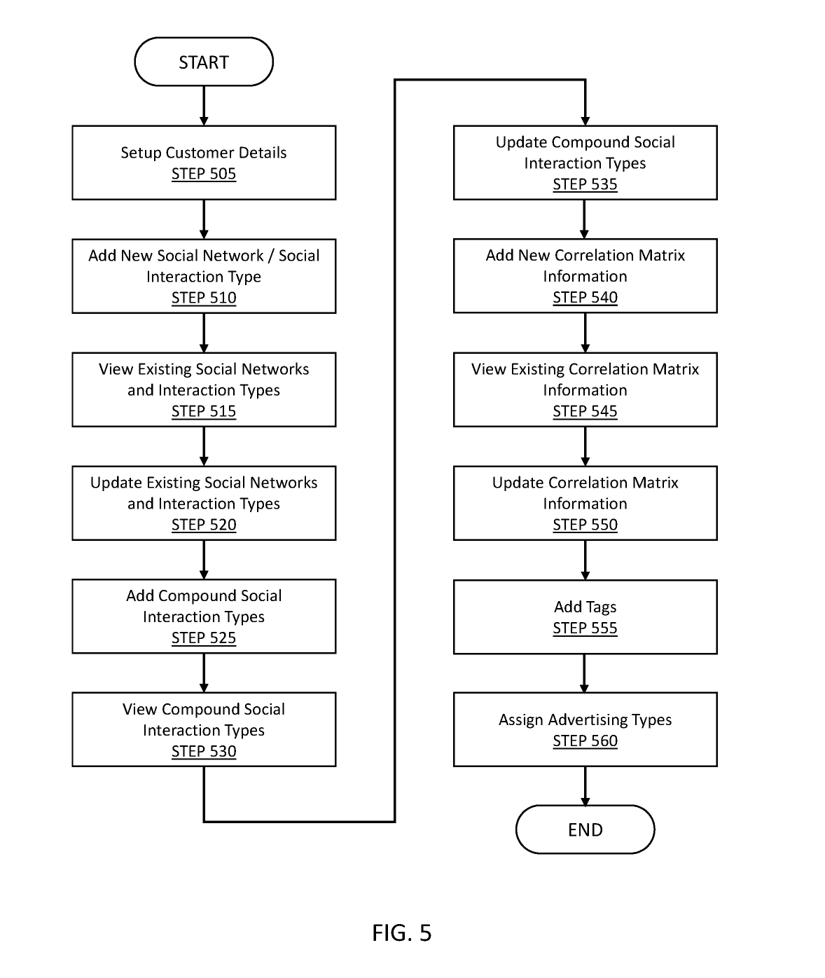

FIG. 4 and FIG. 5 show examples in accordance with one or more embodiments of the present disclosure. Those skilled in the art, having the benefit of this detailed description, will appreciate that the sequence of steps in FIGS. 4 and 5 may differ among embodiments of the present disclosure, and that one or more of the steps may be optional.

In FIG. 4, an exemplary user process, in which engaging in a compound social interaction is demonstrated. This compound social interaction may be made by a user of a website or mobile application who has existing friend or acquaintance relationships on a variety of social networks, such as Facebook, Twitter, Snapchat, Vimeo, VK, LinkedIn, or other social networking utilities.

In STEP 405, a user's request for a compound social interaction is initiated in accordance with one or more embodiments of the present disclosure. As described above, a user views or listens to content on a website or mobile application and wishes to engage with that content through social media interaction(s). For example, the user may wish to perform a compound social interaction about a song the user just listened to on the website, or a story the user just viewed on the mobile application.

In STEP 410, the user is presented with a variety of compound social interactions. For example, the user may be presented with a thumbs up icon, a cheer icon, a crow icon, a frowny face icon, a text box with the words “Tell the world!”, or any number of other icons or text fields to provide abstracted engagement opportunities.

In STEP 415, the user chooses the compound social interaction that best suits their desire for engagement with the content. For example, the manner of engagement may be a thumbs up of a song the user just listened to on the website, or a cheer for a story the user just viewed on the mobile application.

In STEP 420, the user provides any needed social network access credentials for those social networking utilities where there is no existing access credential stored. For example, the user's request may include a social media interaction with the social networking utility Vimeo, and the user has not previously provided their access credentials for Vimeo. Where existing access credentials have been stored already, no new requests need to be made.

In STEP 425, the user receives acknowledgement that the compound social interaction has been completed. For example, this acknowledgement may come in the form of a visual graphic such as a short video of hearts or an audio message saying “Thanks!”, or such other message as may convey the completion of the request.

In STEP 430, the user receives advertising content for a brief period. For example, advertising content could be a 7 second video interstitial, a static image of an advertisement, a 10 second audio spot, or other type of advertising suitable to the user's method of conducting the compound social interaction.

In STEP 435, the user's various social interactions are tracked for performance (e.g. number of views, number of comments, social network utility members who viewed or commented, etc.) for use determining the reach and impact of the various social interactions.

In FIG. 5, an exemplary administrative process, in which developing the compound social interaction correlation matrix is demonstrated. This correlation matrix is developed for a variety of social networks, such as Facebook, Snapchat, LinkedIn, Twitter, Yelp, VK, or other social networking websites by an administrative user of the system (100 in FIG. 1) or such automated method as may be otherwise used.

In STEP 505, customer details are setup in accordance with one or more embodiments of the present disclosure. The customer details may be setup by a customer with an audience using one or more social networks. Customer details may include the name of the customer, networks associated with the customer, initial compound social media types, advertising formats for display, and so forth.

In STEP 510, a new social network and social interaction type is added in accordance with one or more embodiments of the present disclosure. The social network and social interaction type may be entered by a customer. Addition of a new social network will identify the social network (e.g. Facebook, Snapchat, LinkedIn, Twitter, Yelp, VK, etc.), the social interaction type (share, like, comment, love, endorse, promote, etc.), description, comments, and the like. The social network and social interaction type may also be input from a management system external to the compound social interaction application. The management system may plug into the compound social interaction application and the social network to provide management capabilities.

In STEP 515, existing details about social networks and interaction types are viewed in accordance with one or more embodiments of the present disclosure. Network and type details (such as the name of the social network, the type of interaction, description, comments, and other details) may be viewed by the customer. Additionally, a customer may view management reports associated with the customer's usage. These reports may provide information associated with usage and reach of the compound social interactions, and other metrics associated with operations, sales, and management.

In STEP 520, existing details about social networks and social interaction types are updated in accordance with one or more embodiments of the present disclosure. These details may be updated by the customer. Examples of details that may be updated include the name of the social network, the type of interaction, description, comments, and other details.

In STEP 525, a new compound social interaction type is added in accordance with one or more embodiments of the present disclosure. The social network and social interaction type may be entered by a customer. Addition of a new compound social interaction type will identify the name, description, comments, icons, graphics, images, audio, video, commercial opportunities, and the like. The compound social interaction type may also be input from a management system external to the compound social interaction application. The management system may plug into the compound social interaction application and the social network to provide management capabilities.

In STEP 530, existing details about compound social interaction types are viewed in accordance with one or more embodiments of the present disclosure. Various details (such as the name, description, comments, icons, graphics, images, audio, video, commercial opportunities, and other details) may be viewed by the customer. Additionally, a customer may view management reports associated with the customer's usage. These reports may provide information associated with usage and reach of the compound social interactions, and other metrics associated with operations, sales, and management.

In STEP 535, existing details about compound social interaction types are updated in accordance with one or more embodiments of the present disclosure. These details may be updated by the customer. Examples of details that may be updated include the name of the compound social interaction type, description, comments, icons, graphics, images, audio, video, commercial opportunities, and other details.

In STEP 540, a new correlation matrix is added in accordance with one or more embodiments of the present disclosure. The correlation matrix may be entered by a customer. Addition of a new correlation matrix will identify compound social interaction type and correlate it to one or many social interaction types on one or many social networks, previously added. The correlation matrix may also be input from a management system external to the compound social interaction application. The management system may plug into the compound social interaction application and the social network to provide management capabilities.

In STEP 545, existing details about correlation matrix are viewed in accordance with one or more embodiments of the present disclosure. Various details (such as the compound social interaction type, the social network and social interaction type correlated to the compound social interaction type, and other details) may be viewed by the customer. Additionally, a customer may view management reports associated with the customer's usage. These reports may provide information associated with usage and reach of the compound social interactions, and other metrics associated with operations, sales, and management.

In STEP 550, existing details about correlation matrix are updated in accordance with one or more embodiments of the present disclosure. These details may be updated by the customer. Examples of details that may be updated include the compound social interaction type, the social network and social interaction type correlated to the compound social interaction type, and so forth.

In STEP 555, tags are added in accordance with one or more embodiments of the present disclosure. Tags may be added to compound social interaction types, social interaction types, or correlation matrices by the customer, and may be viewable by members of the social network (105 in FIG. 1). Tags specify keywords associated with social interactions (e.g. “love” for a cheer). As with tags for pictures, tags for social interaction types (both simple and compound) may be searchable across the social network (105 in FIG. 1) by members of the social network (105 in FIG. 1). Tags provide for greater ease of reaching potential customers, friends, acquaintances, and non-friends through the social network (105 in FIG. 1). A social interaction type, whether compound or simple, may have multiple tags associated with it.

In STEP 560, advertising types are assigned in accordance with one or more embodiments of the present disclosure. Examples of advertising types that may be updated include advertising networks, size of advertising display, frequency of advertising placement, type of advertising (e.g. audio, video, text, image, popup, overlay, and so forth), and other details. Advertising types may link to external applications and systems that perform advertising placement and so forth. Those skilled in the art, having benefit of this detailed description, will appreciate that there are various mechanisms through which advertising may be displayed or otherwise presented.

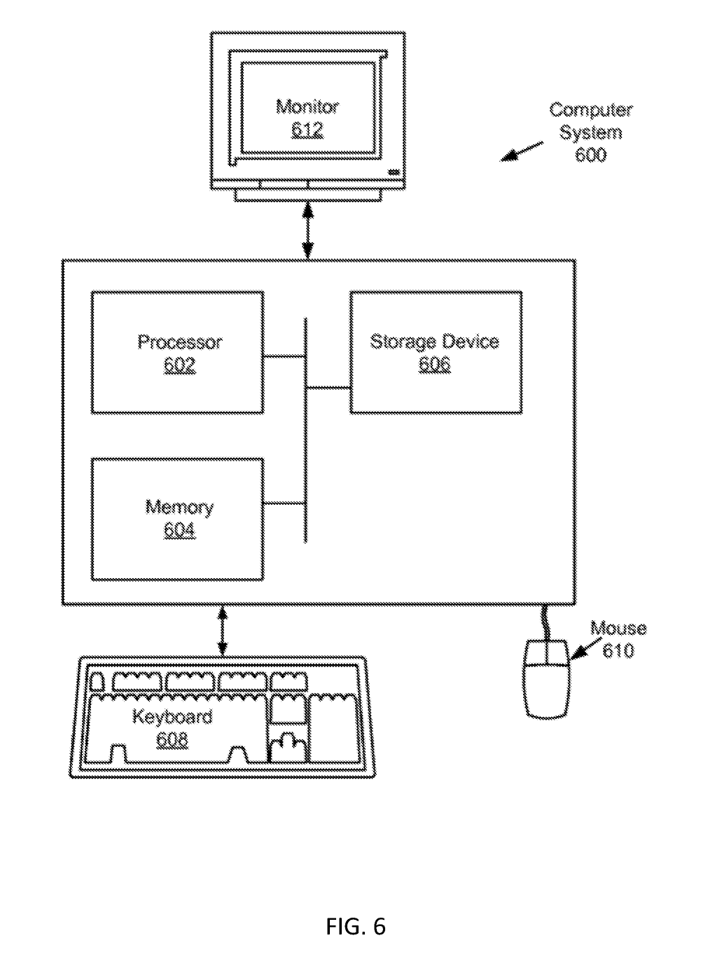

Embodiments of the present disclosure may be implemented on virtually any type of computer regardless of the platform being used. For example, as shown in FIG. 6, a computer system (600) includes one or more processors (602), associated memory (604) (e.g. random access memory (RAM), cache memory, flash memory, etc.), a storage device (606) (e.g. a hard disk, an optical disk drive such as a compact disk drive or digital video disk (DVD) drive, a flash memory stick, etc.), and numerous other elements and functionalities typical of today's computers (not shown). The computer system (600) may also include input means, such as a keyboard (608), a mouse (610), a touch interface (not shown), or a microphone (not shown). Further, the computer (600) may include output means, such as a monitor (612) (e.g. a liquid crystal display (LCD), a plasma display, a cathode ray tube (CRT) monitor, etc.). The computer system (600) may be connected to a network (614) (e.g. a local area network (LAN), a wide area network (WAN) such as the Internet, or any other similar type of network) via a network interface connection (not shown). Those skilled in the art will appreciate that many different types of computer systems exist, and the aforementioned input and output means may take other forms. Generally speaking, the computer system (600) includes at least the minimal processing, input, and/or output means necessary to practice embodiments of the present disclosure.

Further, those skilled in the art will appreciate that one or more elements of the aforementioned computer system (600) may be located at a remote location and connected to the other elements over a network. Further, embodiments of the present disclosure may be implemented on a distributed system having a plurality of nodes, where each portion of the present disclosure (for example, translation engine, data repository, display device driver, and/or any other portion of the present disclosure) may be located on a different node within the distributed system. In one embodiment of the present disclosure, the node corresponds to a computer system. Alternatively, the node may correspond to a processor with associated physical memory. The node may alternatively correspond to a processor with shared memory and/or resources. Further, software instructions to perform embodiments of the present disclosure may be stored on a computer readable medium such as a compact disc (CD), a diskette, a tape, a file, flash drive, or any other computer readable storage device.

While the present disclosure has been described with respect to a limited number of embodiments, those skilled in the art, having benefit of this disclosure, will appreciate that other embodiments can be devised which do not depart from the scope of the embodiments as described herein. Accordingly, the scope of the embodiments should be limited only by the attached claims.

What is claimed is:

1. A method for generating a compound social interaction, comprising:
obtaining a first social interaction type for a particular social network from a first member of a social networking utility;
obtaining a second social interaction type for a particular social network from a second member of a social networking utility;
obtaining a compound social interaction type from a member;
obtaining a correlation between the compound social interaction type and one or more social interaction types on one or more social networks;
receiving, from an inquiring member, a request to perform a compound social interaction;
determining, using a processor, the one or many social interaction types to complete based on the request from the inquiring member;
generating, using the processor, the individual social interactions represented by the inquiring member's request for the compound social interaction; and
performing, based on the request from the inquiring member, one or more social interactions.

2. The method of claim 1, further comprising:
adding the inquiring member to a fan group associated with the compound social interaction.

3. The method of claim 1, further comprising:
receiving a payment upon the completion of a compound social interaction.

4. The method of claim 1, further comprising:
receiving a payment for each click associated with the compound social interaction.

5. The method of claim 1, wherein the compound social interaction is filtered by a network of the inquiring member.

6. The method of claim 1, further comprising:
receiving a plurality of compound configuration details associated with the compound social interaction;
receiving a plurality of configuration details associated with the social interaction for one of more social network utilities; and
associating the plurality of compound configuration details with the first social interaction type and the second social interaction type.

7. The method of claim 6, wherein the plurality of compound configuration details is received from a management system.

8. The method of claim 6, wherein the plurality of configuration details is received from a management system.

9. The method of claim 6, wherein the association between compound social interaction and social interaction is received from a management system.

10. The method of claim 1, further comprising:
generating receiving a plurality of management reports for the compound social interaction.

11. The method of claim 1, further comprising:
generating a plurality of searchable tags for the compound social interaction; and
associating the plurality of searchable tags with the compound social interaction.

12. A system for generating a compound social interaction, comprising:
a processor;
a memory operatively connected to the processor; and
a compound social interaction application executing on the processor, resident in memory, and configured to:
obtain a first social interaction type for a particular social network from a first member of a social networking utility;
obtain a second social interaction type for a particular social network from a second member of a social networking utility;
obtain a compound social interaction type from a member;
obtain a correlation between the compound social interaction type and one or more social interaction types on one or more social networks;
receive, from an inquiring member, a request to perform a compound social interaction;
determine, using a processor, the one or many social interaction types to complete based on the request from the inquiring member;
generate, using the processor, the individual social interactions represented by the inquiring member's request for the compound social interaction; and
perform, based on the request from the inquiring member, one or more social interactions.

13. The system of claim 12, wherein the compound social interaction application is further configured to obtain a plurality of social interactions from an external social networking utility.

14. The system of claim 12, wherein the compound social interaction application is further configured to interact with a management application.

15. The system of claim 12, wherein the compound social interaction application is further configured to interact with a financial application.

16. A non-transitory computer readable storage medium storing instructions to generate a compound social interaction for an inquiring member, the instructions comprising functionality to:
obtain a first social interaction type for a particular social network from a first member of a social networking utility;
obtain a second social interaction type for a particular social network from a second member of a social networking utility;
obtain a compound social interaction type from a member;
obtain a correlation between the compound social interaction type and one or more social interaction types on one or more social networks;
receive, from an inquiring member, a request to perform a compound social interaction;
determine, using a processor, the one or many social interaction types to complete based on the request from the inquiring member;
generate, using the processor, the individual social interactions represented by the inquiring member's request for the compound social interaction; and
perform, based on the request from the inquiring member, one or more social interactions.

17. The non-transitory computer readable storage medium of claim 16, the instructions further comprising functionality to:
receive a plurality of compound configuration details associated with the compound social interaction;
receive a plurality of configuration details associated with the social interaction for one of more social network utilities; and
associate the plurality of compound configuration details with the first social interaction type and the second social interaction type.

18. The non-transitory computer readable storage medium of claim 16, the instructions further comprising functionality to:
receive from a management application a plurality of compound configuration details associated with the compound social interaction;
receive from a management application a plurality of configuration details associated with the social interaction for one of more social network utilities; and
associate the plurality of compound configuration details with the first social interaction type and the second social interaction type.

19. The non-transitory computer readable storage medium of claim 16, wherein the compound social interaction is filtered by a network of the inquiring member.
